(19) United States
(12) Patent Application Publication
(10) Pub. No.: US 2010/0282861 A1
(43) Pub. Date: Nov. 11, 2010

(54) DISPOSABLE POD AND BATTERY OPERATED CHOCOLATE FOUNTAIN

(75) Inventors: Richard Beck Muir, San Diego, CA (US); Jacob Richard Muir, Murrieta, CA (US); James David Sabin, San Diego, CA (US); William F. Polley, Marco Island, FL (US); Chun Sen Wu, (US)

Correspondence Address: KNOBBE MARTENS OLSON & BEAR LLP, 2040 MAIN STREET, FOURTEENTH FLOOR, IRVINE, CA, 92614, US

(73) Assignee: Sephra L.P., San Diego, CA (US)

(21) Appl. No.: 12/760,447

(22) Filed: Apr. 14, 2010

Related U.S. Application Data
(60) Provisional application No. 61/212,563, filed on Apr. 14, 2009.

(51) Int. Cl. B05B 17/08

(52) U.S. Cl. 239/17

(57) ABSTRACT

A disposable pod may be prefilled with chocolate (or other food substance) for use in a chocolate fountain. For example, the manufacturer of the disposable pod, or another party, may fill the disposable pod with melted chocolate after manufacture of the disposable pod.

### CROSS-REFERENCE TO RELATED APPLICATIONS

This application claims the benefit of U.S. Provisional Application No. 61/212,563, filed Apr. 14, 2009 which is hereby incorporated by reference in its entirety herein.

### BACKGROUND

1. Field of the Invention

The invention relates generally to a food dispensing apparatus, and more particularly to a fountain that flows with a fluidic material.

2. Description of the Related Art

Fondue machines typically include a bowl shaped container for holding food substances, such as chocolates or cheeses. One type of fondue machine, referred to as a chocolate fountain, operates by moving melted chocolate that has become fluid through a cylinder by means of an auger that is positioned within the cylinder. The melted chocolate is carried by the auger up to the top of the cylinder where it then flows out of the top of the cylinder and cascades down over one or more tiers until it cascades into a basin of the chocolate fountain. Fruit, or other food items, may be dipped into the cascading chocolate to add a chocolate coating to the food items. The chocolate is then carried by the auger through the cylinder and the process is repeated.

### SUMMARY

In one embodiment, a chocolate fountain comprises an electric motor coupled to a drive shaft so that the drive shaft rotates when the electric motor is powered on, a battery coupled to the electric motor and configured to provide power to the electric motor, a base housing the electric motor, wherein at least a portion of the drive shaft extend from a top surface of the base. In one embodiment, the base is configured to support a disposable pod having a generally bowl shape with an aperture in a central portion of the bowl, wherein the aperture is within a post structure that extend upward from a bottom surface of the disposable pod so that the aperture is higher than the bottom surface of the disposable pod, and wherein the disposable pod is configured to contain a chocolate product and to be supported by the base such that at least a portion of the drive shaft extends through the aperture of the post structure. The chocolate fountain may also include an auger configured for attachment to a portion of the drive shaft that extends above the post structure of the disposable pod so that the auger rotates with the drive shaft, a cylinder sized to fit around at least a portion of the auger, and one or more tiers configured for placement on the cylinder.

In one embodiment, a pod configured for use with a chocolate fountain comprises a generally bowl shaped surface having an open inner area configured to contain a chocolate product and an outer surface sized to rest on and/or engage with a chocolate fountain, a hollow post structure that extends upward from a bottom surface of the pod so that an aperture at the top of the hollow post structure is higher than a bottom of the inside surface of the disposable pod, a chocolate product resting on the inside surface of the bowl shaped surface and filling the pod to a level below the top of the hollow post structure, and a seal positioned on a top surface of the bowl shaped surface in order to cover the open inner area, wherein the seal is configured for manual removal.

In one embodiment, a pod configured for use with a chocolate fountain comprises a generally bowl shaped surface having an open inner area and an outer surface sized to rest on or engage with a surface of a chocolate fountain, a chocolate product resting on the inside surface of the bowl shaped surface, an opening sized to receive a drive shaft of a chocolate fountain therethrough, and a seal positioned on a top surface of the bowl shaped surface in order to cover the open inner area, wherein the seal is configured for manual removal by an end user of the pod.

In one embodiment, a method of manufacturing a pod configured for use with a chocolate fountain comprises using one or more plastic fabrication techniques, fabricating a generally bowl shaped surface having an open inner area and an outer surface sized to rest on or engage with a surface of a chocolate fountain, placing a chocolate product in the inside surface of the bowl shaped surface, and attaching a seal to the bowl shaped surface in order to substantially seal the chocolate product within the open inner area.

### BRIEF DESCRIPTION OF THE DRAWINGS

FIG. 1 is a perspective view of a chocolate fountain and a disposable pod.

FIGS. 2A-2D are different views of a sample disposable pod.

FIG. 3A illustrates a sample disposable pod that is filled with chocolate.

FIG. 3B illustrates a sample disposable pod that is filled with chocolate and includes a seal that protects the chocolate from contaminants.

FIG. 4 is a side view of a disposable pod being placed on a base of a chocolate fountain.

FIG. 5 is a perspective view of the post structure of a disposable pod, wherein a drive shaft of a chocolate fountain extends through an aperture of the post structure

FIG. 6 is a side view of a cylinder of a chocolate fountain.

FIGS. 7A-7C illustrate the three tiers of the chocolate fountain illustrated in FIG. 1.

FIG. 8 is a side view of a sample auger including a spiral flight that extends along the length of the auger.

FIG. 9 is a perspective view of a lower tier supported by ledges on the cylinder.

FIG. 10 illustrates the battery pack of FIG. 1 removed from the battery compartment.

### DETAILED DESCRIPTION OF CERTAIN EMBODIMENTS

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

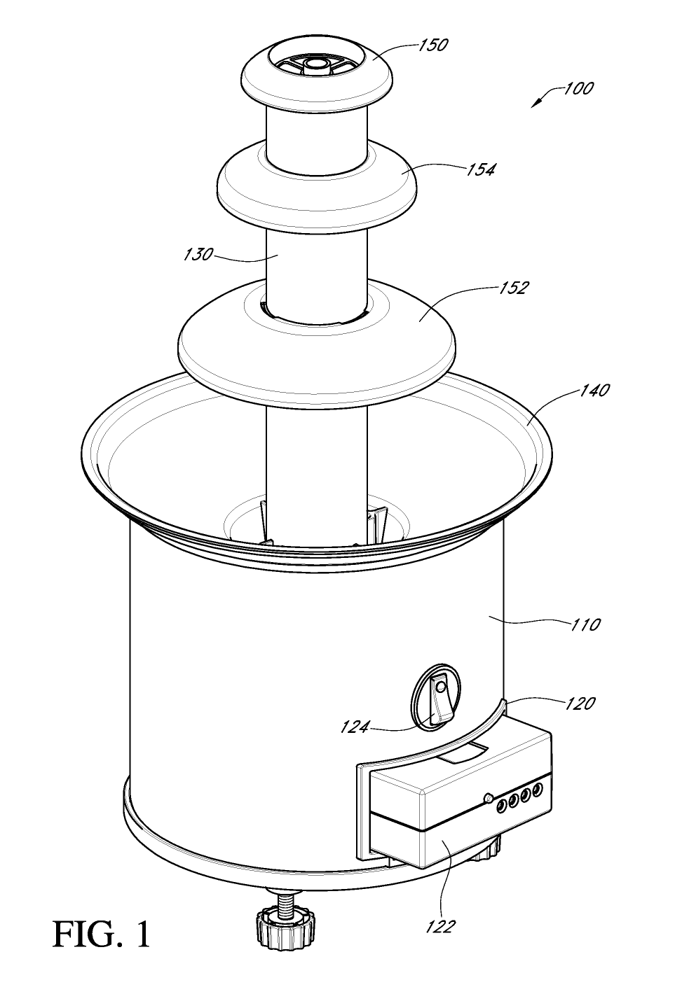

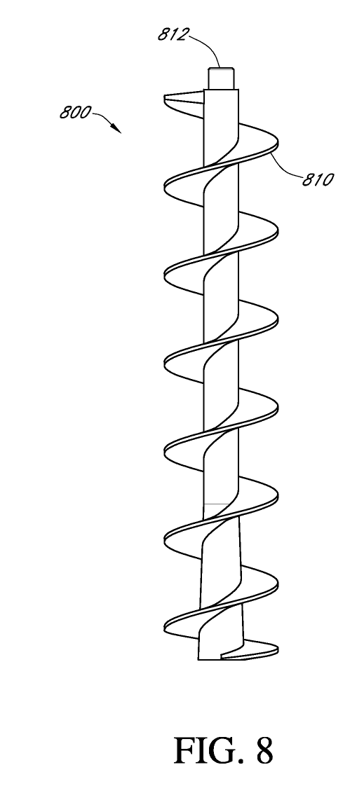

FIG. 1 is a perspective view of a chocolate fountain 100 and a disposable pod 140. In the embodiment of FIG. 1, the chocolate fountain includes a base 110 (which may also be referred to as a housing 110), a cylinder 130, and three tiers 150, 152, 154 supported on the cylinder. The sample chocolate fountain 100 also includes a battery compartment 120 sized to receive a battery pack 122 that includes one or more batteries for powering an electronic motor (not shown) of the chocolate fountain 100. The chocolate fountain 100 also includes a switch 124 that toggles the supply of power from the battery pack 122 to the motor of the chocolate fountain 100 and, thus, toggles the circulation of melted chocolate through the chocolate fountain 100. The chocolate fountain 100 includes an auger (see FIG. 8, for example) within the cylinder 130 that rotates in order to lift melted chocolate upward through the cylinder so that the melted chocolate falls over each of the tiers 150, 154, 152, and returns to the disposable pod 140. Further description of chocolate fountains, and operation of various fountains, may be found in U.S. Pat. Nos. 7,021,556; 7,118,045; 7,182,269; U.S. Pat. No. 7,383,764, each of which is hereby incorporated by reference in its entirety.

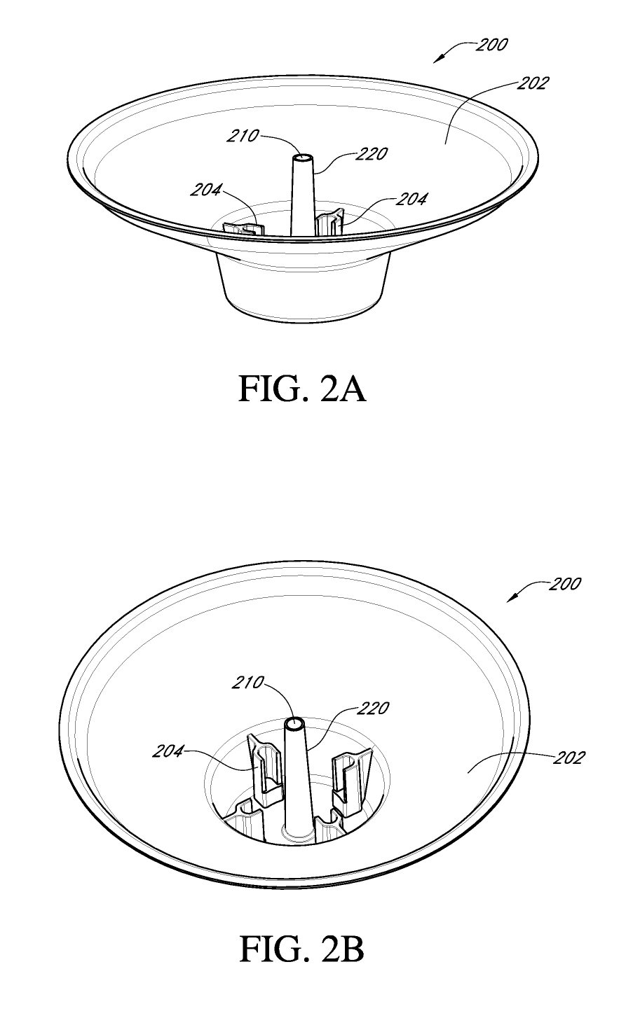

FIGS. 2A-2D are different views of a sample disposable pod 200. In particular, FIG. 2A is a side view, FIG. 2B is a top perspective view, FIG. 2C is a top view, and FIG. 2D is a bottom perspective view, of the same sample disposable pod 200. In one embodiment, the disposable pod 200 is manufactured for limited use, such as a single use, with a suitable chocolate fountain, such as the chocolate fountain 100 of FIG. 1. Thus, the disposable pod 200 may be disposed of after a single use in order to reduce clean-up that is associated with chocolate fountains having permanent bowl or basin structures. In this embodiment, the pod may comprise one or more plastic materials.

In other embodiments, the pod may be configured for re-use, such that the pod may be re-filled with chocolate, or other food product, by an end user in order to re-use the pod with a chocolate fountain. In one embodiment, a re-usable pod comprises metal. In other embodiments, a re-usable pod may be made of any other material, such as one or more plastics.

In one embodiment, the disposable pod 200 is sold prefilled with chocolate for use in a chocolate fountain. For example, the manufacturer of the disposable pod 200, or another party, may fill the disposable pod 200 with melted chocolate after manufacture of the disposable pod. In this embodiment, the end user is spared the difficulty and/or hassle of selecting the appropriate chocolate in the correct amount, and possibly even mixing the chocolate with one or more oils, because the disposable pod 200 is purchased with the desired chocolate and the appropriate quantity of chocolate already in the disposable pod 200. The disposable pod 200 may be fabricated in any known manner, such as by one or more plastic molding techniques, for example. The melted chocolate may remain in a substantially melted form, or it may harden within the disposable pod 200. When a user wants to circulate melted chocolate through chocolate fountain that is configured to receive the disposable pod 200, such as in preparation for a celebration or other event, the user may simply place the disposable pod that is pre-filled with chocolate into a microwave, or others heating device, in order to melt the chocolate to a viscosity that is suitable for circulation throughout the chocolate fountain, and then place the disposable pod 200 on the chocolate fountain for circulation therein.

Although the chocolate fountain of FIG. 1 does not include a heating device, and accordingly, does not require as much power as a similar chocolate fountain including a heating device, the disposable pods discussed herein may also be used with chocolate fountains that do include heating devices, such as certain fountains described in the patents that are incorporated by reference. Additionally, while the disposable pods are discussed herein as being filled with a chocolate substance (e.g., some combination of one or more chocolates and/or oil), disposable pods may be filled with any other fluidic substance, such as melted cheese or other food product. Thus, any reference herein to a chocolate fountain should also be construed to cover a fountain that circulates any other food products. Additionally, the disposable pods discussed herein are configured for containing any food product, whether in a solid or in a fluidic form. The disposable pods may be manufactured in various size and shapes, such as for use with various sizes of chocolate fountains.

FIG. 2A is a side view of the sample disposable pod 200. The sample disposable pod 200 is substantially bowl shaped and includes a post structure 220 that extends from a central region of the disposable pod 200. In this embodiment, the post structure 220 includes an aperture 210 that extends through the length of the post structure 220 and is sized to receive a drive shaft that provides a rotational force to an auger of a chocolate fountain.

In the views of the disposable pod 200 provided in FIGS. 2B and 2C, four cylinder engagement mechanisms 204 are shown. In this embodiment, the engagement mechanisms 204 are substantially Y-shaped such that each engagement mechanism 204 includes two members configured to engage with an outer surface of a cylinder in order to support the cylinder above the disposable pod 200. In this embodiment, the engagement mechanisms 204 are configured to support the cylinder via a friction fit, such that no moving parts are necessary in order to stabilize the cylinder. In other embodiments, other cylinder attachment mechanisms may be used. For example, fewer or additional engagement mechanisms 204, such as two, three, or five engagement mechanisms, similar to those illustrated in FIGS. 2B and 2C, may be included in a disposable pod. Additionally, attachment mechanisms of different shapes may be used to support the cylinder. In other embodiments, any other means of attaching and/or supporting the cylinder to near or on a portion of the pod 200 may be used.

As shown in FIG. 2D, which is a bottom perspective view of the disposable pod 200, the aperture 210 extends through the bottom of the disposable pod 200. The aperture is sized for a drive shaft to extend therethrough in order to engage with an auger and provide a rotational force to the auger. The bottom surface of the disposable pod 200 is shaped to fit on and/or within a sub-basin of a chocolate fountain. Different shapes of disposable pods may be manufactured for use with chocolate fountains having differently shaped sub-basins.

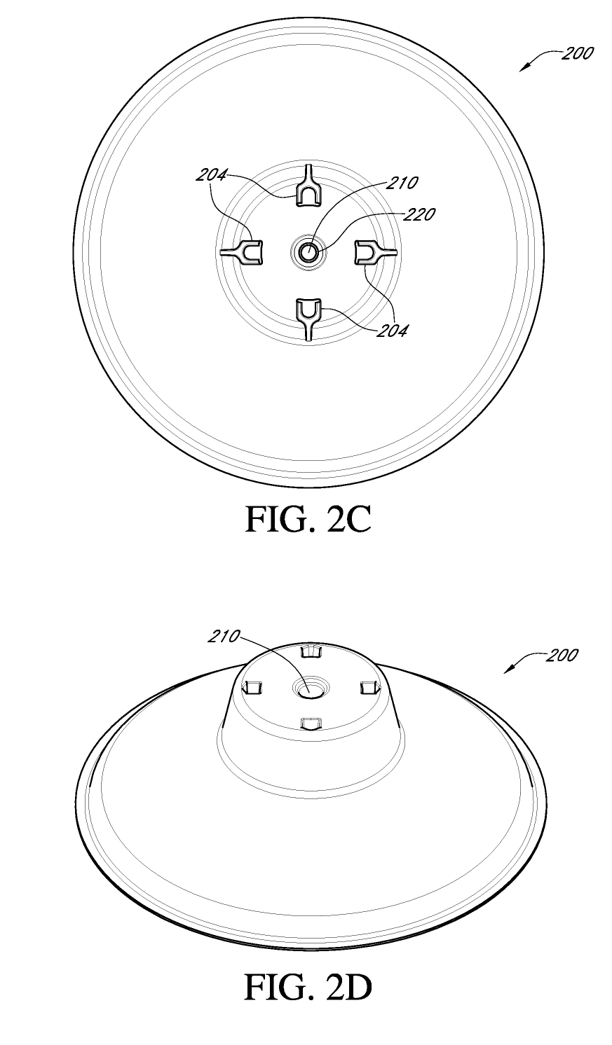

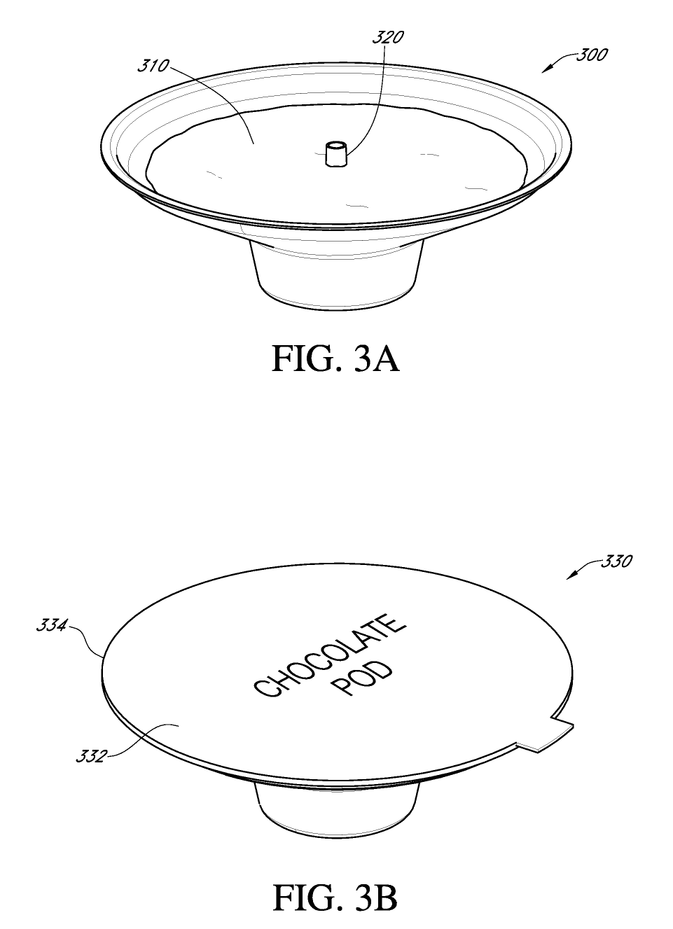

FIG. 3A illustrates a sample disposable pod 300 that is filled with melted chocolate. As noted above, in one embodiment the disposable pod may be pre-filled with chocolate, or other foods products, prior to providing to a retailer or end-user, for example. Disposable pods with various types and/or blends of chocolate may be manufactured and sold. In the embodiment of FIG. 3A, the post structure 320 extends above a top surface of the chocolate so that the chocolate, especially when melted, does not enter the aperture of the post structure 320 and possibly drip down into a motor of the chocolate fountain on which the disposable pod 300 has been placed.

FIG. 3B illustrates a sample disposable pod 330 that is pre-filled with chocolate and includes a seal 332 that protects the chocolate from contaminants and/or from leaking from the disposable pod 330. In the embodiment of FIG. 3B, the seal includes markings labeling the pod 332 with “Chocolate Pod.” In other embodiments, the seal 332 may not include any markings or the seal 332 may include any additional markings, such as logos, company names, information on the particular chocolate blend, nutritional information, price information, etc. Any suitable material may be used for the seal 332 to cover the bowl structure of the disposable pod 330 that contains the food product. For example, in one embodiment a plastic seal be placed on the disposable pod 330 and melted to the top edge 334 of the disposable pod 330 to create a seal on top of the disposable pod 330. Seal 332 is preferably easily removable from the disposable pod 330 so that the chocolate, or other food product within the disposable pod 330, is accessible to the chocolate fountain in which the disposable pod 330 is placed. In one embodiment, the seal 332 is configured for puncturing during heating of the chocolate within the pod 330. For example, an end-user may puncture the seal 332 with a fork or a knife to provide air vents that release pressure that may build up as the chocolate is heating in a microwave, for example. In this embodiment, after the chocolate is heated to a temperature that creates a properly viscous chocolate substance, the seal 332 may be entirely removed from the disposable pod 330.

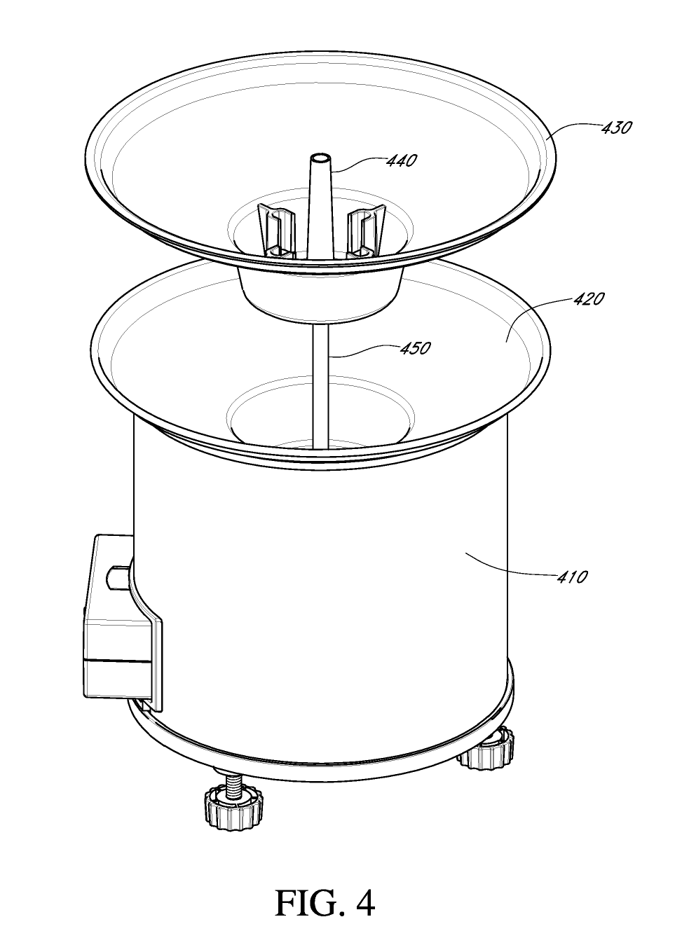

FIG. 4 is a side view of a disposable pod 430 being placed on a base 410 of a chocolate fountain. In the embodiment of FIG. 4, a drive shaft 450 is shown extending from a sub-basin 420 of the base 410. The drive shaft of 450 is coupled to an electronic motor such that when the electronic motor is activated the drive shaft rotates. The post structure 440 of the disposable pod 430 includes an aperture sized to receive the drive shaft 450 such that the drive shaft exams through the post structure 440.

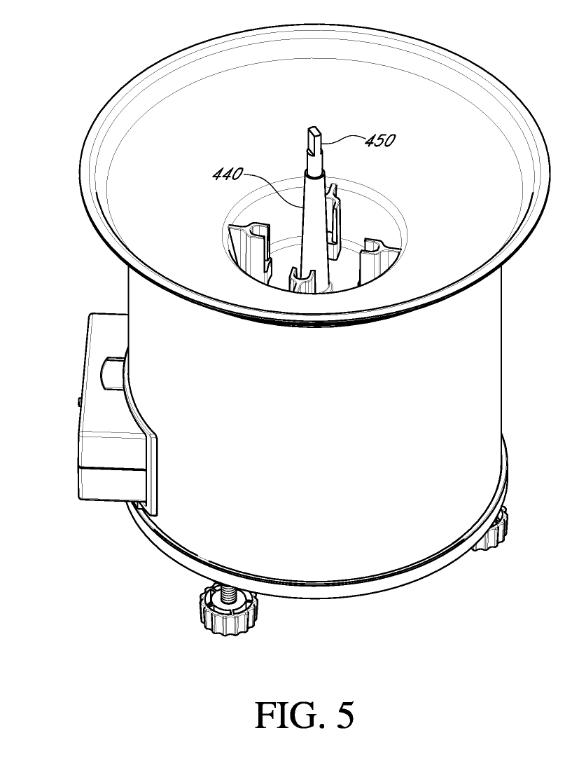

FIG. 5 is a close-up perspective view of the post structure 440 of FIG. 4 having the drive shaft 450 extending therethrough. As shown in FIG. 5, the drive shaft 450 includes a non-round shape at the end of the drive shaft that is configured to engage a similarly sized aperture of an auger in order to fittingly engage with the auger so that a rotational force may be transferred from the drive shaft to the auger.

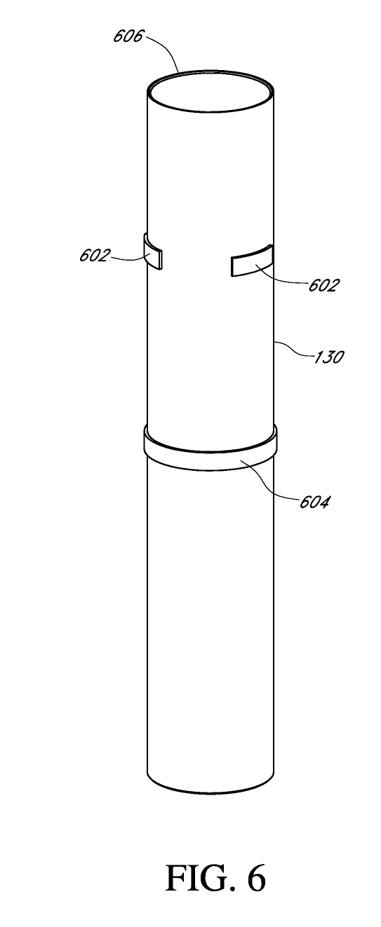

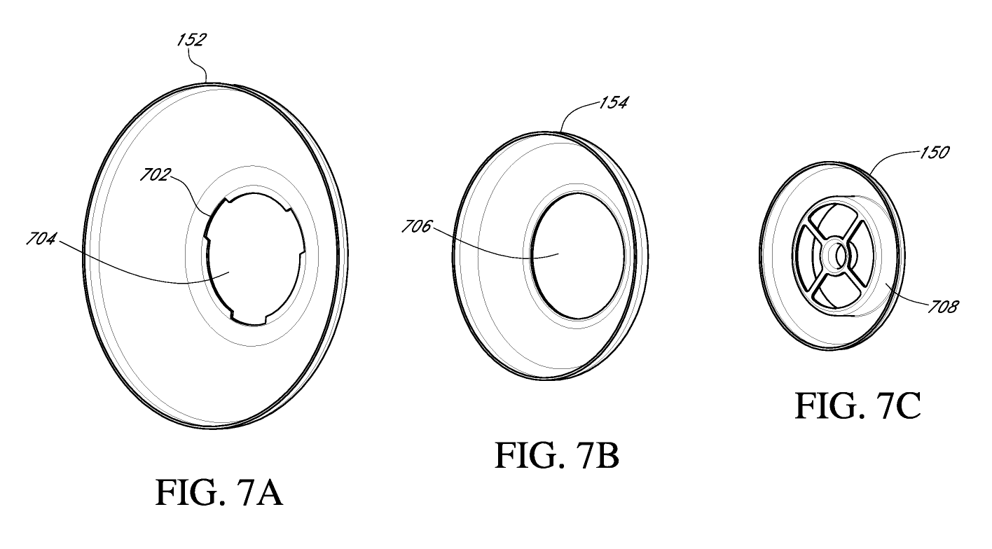

FIG. 6 is a side view of the cylinder 130 of the chocolate fountain illustrated in FIG. 1 and FIGS. 7A-7C are bottom views of the three tiers 150, 152, 154 of FIG. 1. In particular, FIG. 7A illustrates lower tier 152, FIG. 7B illustrates middle tier 154, and FIG. 7C illustrates upper tier 150 (which may also be referred to as a crown in view of the location of the upper tier on top the cylinder 130). As illustrated in FIG. 6, the cylinder includes ledges 602 at first location and a ledge 604 at a second location that are configured for supporting respective tiers. In operation, the lower tier 152 is initially lowered onto the ledge 604 by sliding the tier 152 over a top end 606 of the cylinder 130. As shown in FIG. 7A, the lower tier 152 includes slots 702 around a central aperture 704. In this embodiment, the aperture 704 is sized to fit around circumference of the cylinder 130 and the slots 702 are positioned to match an orientation of the ledges 602 on the cylinder 130. Thus, the lower tier 152 may be rotated about the cylinder 130 in order to line up the slots 702 with the ledges 602 so that the tier 152 may be lowered below the ledges 602 towards the ledge 604. The ledge 604, in this embodiment, extends around the cylinder 130 and, accordingly, supports the lower tier 152 despite the lower tier having slots 702.

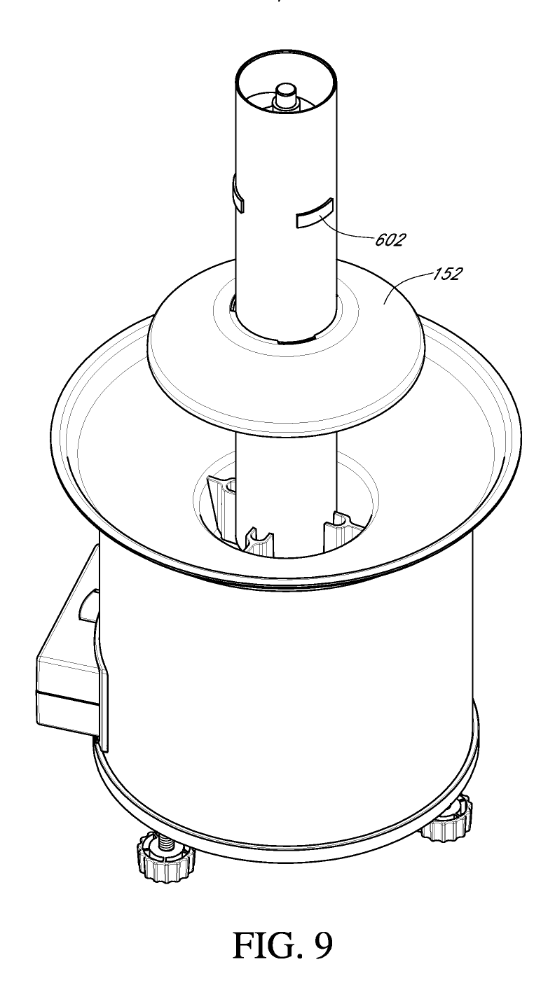

With the lower tier 152 in place on the ledge 604, such as is illustrated in FIG. 9, the middle tier 154 may be put in position on the cylinder 130. In particular, the aperture 706 of middle tier 154 is sized to receive the cylinder 130 but is not large enough to allow the tier 154 to pass over the ledges 602 and does not include slots (such as slots 702 of tier 152) that would allow the middle tier 154 to pass over the ledges 602. Accordingly, the middle tier 154 rests on, and is supported by, the ledges 602.

In this embodiment, the upper tier 150 includes an inner rim 708 that is sized to fit within the aperture of the cylinder 130 at the top and, such that the upper tier 150 rests upon the top end 606 of the cylinder 130. In other embodiments, the upper tier 150 may be supported on the cylinder 130 in other manners. Additionally, depending on the embodiment, fewer or additional tiers may be used on various chocolate fountains, and the tiers may be attached in different manners. For example, tiers may be attached in any manner described in the related patents that are incorporated by reference above.

FIG. 8 is a side view of a sample auger 800 including a spiral flight 810 that extends along the length of the auger 800. The auger 800 includes an aperture on a lower end 812 that is sized to engage with the top end of the drive shaft 450 (FIG. 5) so that the drive shaft may provide a rotational force to the auger. The aperture on the lower end 812 of the auger 800 may further be sized to receive at least a top portion of the post structure (e.g., structure 440 of FIG. 5) to allow the auger to be lowered into the pod to a depth that is sufficient for at least a lower portion of the spiral flight 810 to be within the melted chocolate so that the melted chocolate may be lifted upward within the cylinder by the rotation of the auger 800 within the cylinder.

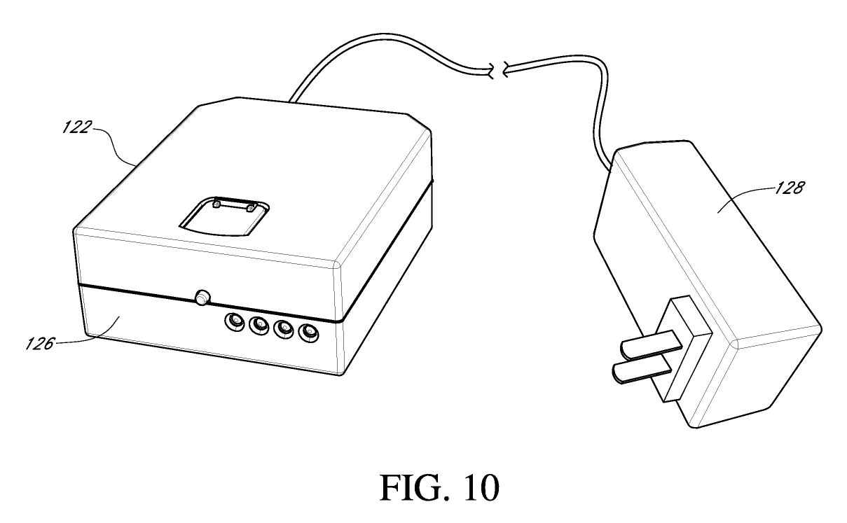

FIG. 10 illustrates the battery pack 122 removed from the battery compartment 120 (FIG. 1) of chocolate fountain 100. In this embodiment, the battery pack includes a light 126, such as one or more LEDs, that provides an indication of whether the battery pack is currently being discharged by operation of the motor of a chocolate fountain. In one embodiment, the battery pack may include an indicator, such as one or more LEDs, of a charge level of the battery pack 122. The battery pack 122 is shown coupled to an AC adapter 128 that may be used to charge the rechargeable batteries of the battery pack 122. In one embodiment, the battery pack 122 opens to receive disposable batteries such that the battery pack may provide power to a chocolate fountain even when the charging of the battery pack is not possible.

In other embodiments, the battery could be external to the chocolate fountain. Additionally, in one embodiment, the chocolate fountain may be powered by an AC adapter that plugs into a wall socket, for example. In this embodiment, the chocolate fountain may or may not include a battery compartment and/or battery pack. In other embodiments, the chocolate fountain may be powered by any other suitable means.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the components, features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A fountain comprising:
an electric motor coupled to a drive shaft so that the drive shaft rotates when the electric motor is powered on;
a battery coupled to the electric motor and configured to provide power to the electric motor;
a base housing the electric motor, wherein at least a portion of the drive shaft extends from a top surface of the base and wherein the base is configured to support a disposable pod having a generally bowl shape with an aperture in a central portion of the bowl, wherein the aperture is within a post structure that extend upward from a bottom surface of the disposable pod so that the aperture is higher than the bottom surface of the disposable pod, and wherein the disposable pod is configured to contain a food product and to be supported by the base such that at least a portion of the drive shaft extends through the aperture of the post structure;
an auger configured for attachment to a portion of the drive shaft that extends above the post structure of the disposable pod so that the auger rotates with the drive shaft;
a cylinder sized to fit around at least a portion of the auger; and
one or more tiers configured for placement on the cylinder.

2. The fountain of claim 1, wherein the auger comprises an opening on a lower end of the auger, the opening sized to receive the drive shaft and at least a portion of the post structure.

3. The fountain of claim 1, wherein the opening on the lower end of the auger comprises a non-round aperture sized to fit a top end of the drive shaft.

4. The fountain of claim 1, further comprising a battery pack configured to house one or more batteries.

5. The fountain of claim 1, wherein the battery is rechargeable.

6. The fountain of claim 1, further comprising an electric connector sized to receive a connector of an AC power adapter configured for engagement with a standard AC wall socket.

7. A pod configured for use with a fountain configured to circulate a food product, the pod comprising:
a generally bowl shaped surface having an open inner area configured to contain a food product and an outer surface sized to rest on and/or engage with a fountain configured to circulate the food product;
a hollow post structure that extends upward from a bottom surface of the pod so that an aperture at the top of the hollow post structure is higher than a bottom of the inside surface of the disposable pod;
a food product resting on the inside surface of the bowl shaped surface and filling the pod to a level below the top of the hollow post structure; and
a seal positioned on a top surface of the bowl shaped surface in order to cover the open inner area, wherein the seal is configured for manual removal.

8. The pod of claim 7, wherein the pod is disposable after the food product is substantially used by an end user of the pod.

9. The pod of claim 8, wherein the food product comprises one or more of chocolate, cheese, yoghurt, or caramel.

10. The pod of claim 7, wherein the pod is reusable.

11. The pod of claim 7, wherein the pod is configured for placement in a microwave in order to heat the food product and in order to provide a viscous food product without affecting the shape of the bowl shaped surface.

12. The pod of claim 7, wherein the food product comprises sweetened and/or unsweetened chocolate and one or more of oil, cocoa butter, flavor extract, or amaretto.

13. The pod of claim 7, wherein the food product comprises one or more of a single block of chocolate, chocolate chips, chocolate pieces, or chocolate blocks.

14. The pod of claim 7, wherein the pod comprises one or more of plastic or metal.

15. A pod configured for use with a fountain, the pod comprising:
a generally bowl shaped surface having an open inner area and an outer surface sized to rest on or engage with a surface of a fountain;
a food product resting on the inside surface of the bowl shaped surface;
an opening sized to receive a drive shaft of a fountain therethrough; and
a seal positioned on a top surface of the bowl shaped surface in order to cover the open inner area, wherein the seal is configured for manual removal by an end user of the pod.

16. The pod of claim 15, wherein the pod comprises plastic.

17. The pod of claim 16, wherein the plastic pod is disposable.

18. The pod of claim 15, wherein the surface of the fountain comprises a sub-basin of the fountain.

19. The pod of claim 15, wherein the seal comprises one or more marketing images on a top surface of the seal.

20. A method of manufacturing a pod configured for use with a fountain, the method comprising:
providing a generally bowl shaped surface fabricated using one or more plastic fabrication techniques having an open inner area and an outer surface sized to rest on or engage with a surface of a fountain;
placing a food product in the inside surface of the bowl shaped surface; and
attaching a seal to the bowl shaped surface in order to substantially seal the food product within the open inner area.

21. The method of claim 20, wherein attaching the seal to the bowl shaped surface comprises heating at least a portion of the seal touching the top of the bowl sufficiently to cause the seal to attach to the top of the bowl.
